(19) United States
(12) Patent Application Publication
(10) Pub. No.: US 2025/0019246 A1
(43) Pub. Date: Jan. 16, 2025

(54) Method for producing high-purity silicon carbide powder

(71) Applicant: Nippon Kornmeyer Carbon Group GmbH, Windhagen (DE)

(72) Inventors: Torsten KORNMEYER, Königswinter (DE); David KLEIN, Hennef (Sieg) (DE)

(73) Assignee: Nippon Kornmeyer Carbon Group GmbH, Windhagen (DE)

(21) Appl. No.: 18/713,095

(22) PCT Filed: Nov. 24, 2022
(86) PCT No.: PCT/EP2022/083109

§ 371 Date: May 23, 2024

(30) Foreign Application Priority Data
Dec. 2, 2021 (DE) 10 2021 131 748.7

(51) Int. Cl. C01B 32/97; C01B 32/205

(52) U.S. Cl. CPC C01B 32/97; C01B 32/205

(57) ABSTRACT

A method for producing high-purity silicon carbide powder includes filling starch-based packing chips or expanded starch as organic raw material into a container open at the top; introducing the container filled with the raw material into a furnace and heating the packing chips, or the expanded starch, gradually to a temperature of 2,000° C. whilst feeding inert gas or under vacuum to graphitize the packing chips or the expanded starch into porous graphite pieces; feeding halogen gas, such as chlorine or fluorine, into the furnace to purify the porous graphite pieces at a temperature of >1,800° C. to remove foreign metals from the porous graphite pieces by forming metal chloride, and converting the porous graphite pieces into powdered silicon carbide by feeding SiO with argon as carrier gas at a temperature of >1,200° C. at a pressure of 30 mbar or higher.

### CROSS-REFERENCE TO RELATED APPLICATION

This application is a national stage application, filed under 35 U.S.C. § 371, of International Patent Application PCT/EP2022/083109, filed on Nov. 24, 2022, which claims the benefit of German Patent Application DE 10 2021 131 748.7, filed on Dec. 2, 2021.

### TECHNICAL FIELD

The disclosure relates to a method for producing high-purity silicon carbide powder (SiC powder) for the production of sintered articles made of silicon carbide or for use in the production of electronic components.

### BACKGROUND

It is known that silicon carbide can be produced by sublimation and epitaxial growth, which can be carried out from the gas phase without a seed crystal. To this end, silicon carbide is epitaxially grown from a vapor enriched with carbon and silicon, thus yielding a silicon carbide single crystal. This process is carried out at a temperature of approx. 2500° C.

EP 0 403 887 A1 describes a method for producing monocrystalline silicon carbide by sublimation and partial decomposition of crystalline SiC powder and growth on a seed crystal in a reaction vessel under protective gas at a low temperature gradient, in which crystal growth is accomplished by setting a silicon excess in the SiC powder by adding, for example, elemental silicon.

It is quite complicated to realize such a method, and a silicon carbide powder produced in such a way may still contain traces of impurities, such as heavy metal silicides or carbides, which are an impediment to use in, for example, electronic components, meaning that the starting material, or the silicon carbide powder produced, must be subjected to supplementary chemical cleaning, if that is possible at all.

The pulverized silicon carbide can then be shaped into a shaped article by hot pressing or used in some other way, in which case the silicon carbide powder may also be mixed with a boron-containing additive to achieve increased oxidation or corrosion resistance.

DE 690 19 339 T2 discloses a method for producing silicon carbide by a carbothermic reduction. To this end, a disperse reactive mixture of a silicon dioxide source and a carbon source is heated to a sufficiently high temperature by a heating zone at a heating rate of at least 100° C./second, thereby forming a product which, after combustion of excess carbon and treatment with hydrofluoric acid to remove excess silicon dioxide, consists of at least 80% by weight of silicon carbide crystals having a specified size distribution.

The carbon source used is carbon black, acetylene soot, carbohydrates or starch, and the silicon dioxide source used is silicon dioxide, silica dust, colloidal silicon dioxide.

DE 195 37 430 A1 relates to a method for producing high-purity silicon carbide powder for production of a silicon carbide single crystal, comprising the steps of forming silicon carbide, which is produced by calcination of tetraalkoxysilane, tetraalkoxysilane polymer and silicon dioxide and a carbon starting material in the form of a high-purity organic compound in an oxidation-free environment, followed by high-temperature treatment to obtain silicon carbide powder.

DE 697 04 638 T2 describes a method for producing a sintered article made of silicon carbide. The sintered article is produced by sintering a homogeneous mixture composed of a silicon source containing at least one liquid silicon source, of a carbon source containing at least one liquid organic compound and of a polymerization or crosslinking catalyst by heating to 2000° C. to 2400° C. under high pressure and in a nonoxidizing atmosphere.

Furthermore, DE 10 2008 042 499 A1 describes a method for producing high-purity silicon carbide from carbohydrates and silicon oxide by calcination. To this end, silicon carbide, carbon and/or silicon oxide is reacted at low temperatures of 400° C. to 1400° C. in a first pyrolysis step and calcined at higher temperatures of up to 3000° C., such that a high-purity silicon carbide is formed by aftertreatment by passive oxidation at temperatures of around 800° C.

### SUMMARY

It is therefore an object of the disclosure to provide a method for cost-effectively producing high-purity silicon carbide powder. The object is achieved by:
filling starch-based packaging chips or expanded starch as organic raw material into an open-top vessel,
placing the filled vessel in a furnace and gradually heating the packaging chips or expanded starch to a temperature of 2000° C. under feeding of protective gas or under vacuum for graphitization of the packaging chips or expanded starch into porous graphite pieces,
feeding halogen gas into the furnace for cleaning of the porous graphite pieces at a temperature of >1800° C. for removal of foreign metals from the porous graphite pieces by formation of metal chloride, and
converting the porous graphite pieces into pulverulent silicon carbide by sublimation of pulverulent SiO into a gas phase with argon as carrier gas at a temperature of >1200° C. and at a pressure of 30 mbar or higher.

The particular advantage of the method according to the disclosure can be considered that of, firstly, being able to use a readily available organic raw material as the starting material. These are the slightly green packaging chips which are made from cornstarch or potato starch, a PVA adhesive, and tallow and water by extrusion and which, after use thereof as packaging material, which would otherwise be waste, can also be utilized for the production of high-purity fine-grained silicon carbide powder.

Alternatively, cornstarch or potato starch which is pure or has been mixed with a PVA adhesive and has been expanded can also be used as organic raw material.

In a first development of the invention, the conversion into silicon carbide is effected at a temperature of 1520° C.

The conversion into silicon carbide can also be effected at a pressure of 950 mbar, the pressure currently used mainly influencing the homogeneity and speed of the conversion.

The conversion into silicon carbide is effected in a long-running process which can last 50 to 100 hours depending on the size of the furnace and the amount of material to be converted.

Lastly, the graphitization can be preceded by a stabilization and homogenization operation at a stabilization temperature of 140° C. to not more than 450° C., preference being given to a temperature of 250° C., in order to allow outgassing of volatile substances.

The stabilization and homogenization of the prefabricated shaped article can be effected while heating the furnace to the stabilization temperature.

If the SiC powder contains excess carbon, the latter can be oxidized, i.e., combusted, at >500° C. while feeding oxygen.

Furthermore, excess silicon in the SiC powder can be removed, for example, by treatment with hydrofluoric acid (HF) or ammonium fluoride (NH4F).

In a particular embodiment of the invention, less than 100% of the porous graphite pieces are converted into SiC powder, this being followed by oxidation of the residual carbon at >500° C. while feeding oxygen, such that pure SiC remains.

### DETAILED DESCRIPTION

The invention will now be more particularly elucidated with reference to a working example.

The starting material preferably used for the production of high-purity silicon carbide powder is commercially available organic packaging chips which have been shaped on the basis of starch, preferably cornstarch or potato starch, mixed with PVA (polyvinyl alcohol) or VA (vinyl alcohol) as adhesive and with water and tallow to form a paste, and produced by extrusion using a customary extruder. The starting material is therefore a starting material that is produced cost-effectively and is purely organic, and the organic packaging chips are slightly green, white or yellow in color so as to be able to distinguish them from polystyrene chips.

These packaging chips, as organic raw material, are filled into a flat, open-top vessel, which is then placed in a furnace and gradually heated to a temperature of 2000° C. under feeding of protective gas or under vacuum for graphitization of the packaging chips. Porous graphite pieces are formed from the packaging chips, while volatile components of the packaging chips, such as water, escape at the same time.

Halogen gas, mainly chlorine or fluorine, is then introduced into the furnace for cleaning of the porous graphite pieces at a temperature of >1800° C., such that foreign metals are removed from the porous graphite pieces by formation of metal chloride.

This graphitization and cleaning process can take a few hours, and the heating of the furnace to the graphitization temperature should be done in steps.

After the cleaning process has been completed, the porous graphite pieces in the furnace are converted into a pulverulent silicon carbide by feeding SiO with argon as carrier gas at a temperature of >1200° C. at a pressure of 30 mbar or higher.

To this end, the conversion into silicon carbide is preceded by introduction of pulverulent SiO into the furnace, which sublimates, i.e., becomes gaseous, at >1200° C., with CO (carbon monoxide) being simultaneously formed during the conversion of the carbon into SiC.

The conversion into silicon carbide is effected in a long-running process which can last some hours. Depending on the size of the furnace and the amount of material to be converted, the process can last 50 to 100 hours.

It will be understood that starch, such as cornstarch or potato starch, mixed with a PVA adhesive can also be used as an organic starting material instead of the organic packaging chips. This porous organic starting material can then be processed further to form silicon carbide as described above.

The conversion into silicon carbide is preferably effected at a temperature of 1520° C. and at a pressure of 950 mbar.

If free silicon or carbon is still present after the conversion into SiC, an aftertreatment of the powder can be performed at >500° C., such that the free carbon is oxidized with oxygen. If the proportion of free silicon should be too high, an aftertreatment by etching with hydrofluoric acid or ammonium fluoride can also be carried out.

Another way of producing pure SiC is to first convert less than 100% of the porous graphite pieces into SiC powder and to then remove the residual carbon by oxidation.

However, this would involve the use of a suitable furnace which is clean and oxygen-resistant.

In a particular variant of the invention, less than 100% of the porous graphite pieces are converted into SiC powder and the remaining residual carbon is then oxidized at >500° C. while feeding oxygen, such that pure SiC remains.

1-9. (canceled)

10. A method for producing high-purity silicon carbide powder, comprising:
filling a raw material comprising starch-based packaging chips or expanded starch into an open-top vessel;
placing the open-top vessel filled with the raw material in a furnace and gradually heating the starch-based packaging chips or expanded starch to a temperature of 2000° C. under feeding of protective gas or under vacuum for graphitization of the raw material into porous graphite pieces;
feeding halogen gas into the furnace for cleaning the porous graphite pieces at a temperature of >1800° C. for removing foreign metals from the porous graphite pieces by forming metal chloride; and
converting the porous graphite pieces into silicon carbide powder at a temperature of >1200° C. at a pressure of 30 mbar or higher by feeding SiO with argon as carrier gas into the furnace for a period of 50-100 hours.

11. The method as claimed in claim 10, wherein the raw material used is pure cornstarch or cornstarch mixed with a PVA adhesive.

12. The method as claimed in claim 10, wherein the converting the porous graphite pieces into the silicon carbide powder is effected at a temperature of 1520° C.

13. The method as claimed in claim 10, wherein the converting the porous graphite pieces into the silicon carbide powder is performed at a pressure of 950 mbar.

14. The method as claimed in claim 10, wherein the heating of the furnace is effected in steps.

15. The method as claimed in claim 10, further comprising: oxidizing the silicon carbide powder at >500° C. while feeding oxygen to eliminate excess carbon.

16. The method as claimed in claim 10, further comprising: treating the silicon carbide powder with hydrofluoric acid (HF) or ammonium fluoride (NH4F) to eliminate excess silicon.

17. The method as claimed in claim 10, comprising
converting less than 100% of the porous graphite pieces into the silicon carbide powder and
oxidizing residual carbon at >500° C. while feeding oxygen.

18. The method as claimed in claim 10, wherein converting the porous graphite pieces into silicon carbide powder includes introducing the SiO in form of pulverulent SiO into the furnace and causing the SiO to sublimate.
